(19) United States
(12) Patent Application Publication
(10) Pub. No.: US 2019/0110273 A1
(43) Pub. Date: Apr. 11, 2019

(54) METHOD AND DEVICE IN UE AND BASE STATION USED FOR WIRELESS COMMUNICATION

(71) Applicant: Shanghai Langbo Communication Technology Company Limited, Shanghai (CN)

(72) Inventors: Qi Jiang, Shanghai (CN); Xiaobo ZHANG, Shanghai (CN)

(73) Assignee: Shanghai Langbo Communication Technology Company Limited, Shanghai (CN)

(21) Appl. No.: 16/152,252

(22) Filed: Oct. 4, 2018

(30) Foreign Application Priority Data
Oct. 5, 2017 (CN) 201710925967.4

(51) Int. Cl. H04W 68/02; H04W 72/04

(52) U.S. Cl. CPC H04W 68/02; H04W 72/0446

(57) ABSTRACT

The present disclosure provides a method and a device in a User Equipment (UE) and a base station used for wireless communication. The UE detects a first signaling in only K first-type slot groups in K first-type slot sets respectively; wherein the K first-type slot groups belong to the K first-type slot sets respectively; any one first-type slot set of the K first-type slot sets includes a positive integer number of slots, and any one slot group of the K slot groups includes a positive integer number of slots; the positions of the K first-type slot groups in the K first-type slot sets are different from each other, and the positions of the K first-type slot groups in the K first-type slot sets are all related to an ID of the UE; and the first signaling is used for determining paging related information.

### CROSS REFERENCE TO RELATED APPLICATION

This application claims the priority benefit of Chinese Patent Application Serial Number 201710925967.4, filed on Oct. 5, 2017, the full disclosure of which is incorporated herein by reference.

### BACKGROUND

### Technical Field

The present disclosure relates to transmission methods and devices in wireless communication systems, and in particular to a transmission method and device for radio signals supporting multiple paging schemes.

### Related Art

In traditional Long-Term Evolution (LTE) and Long-Term Evolution Advanced (LTE-A) systems, User Equipment (UE) calculates a time domain position of a corresponding Paging Frame (PF) in all radio frames according to DRX configurations, International Mobile Subscriber Identification Number (IMSI) and base station configuration information, then calculates a time domain position of a Paging Occasion (PO) belonging to the UE in the PF according to the ISMI and the base station configuration information, and finally searches for paging related information in the subframe corresponding to the PO. Taking Frequency Domain Multiplexing (FDD) for example, only SFs {#0, #4, #5, #9} are available for the PO, and, for a given UE, the positions of the POs in all PFs are the same. The above scheme in LTE and LTE-A guarantees that the positions of the POs actually monitored by the UE in the entire time axis are basically evenly distributed.

In 5G New Radio Access Technology (NR) systems, the distribution of a Common Search Spaces (CSS) is flexible and configurable; and, for different application scenarios, one UE may support multiple types of CSS configurations. If paging information is indicated still by CSS and the designs of PF and PO in LTE and LTE-A are still employed, the positions of the POs monitored by a UE will become uneven with the change of the configuration of the CSS, thus the performance and efficiency of paging are impacted. Therefore, it is needed to design a new paging scheme.

### SUMMARY

In 5G systems, the CSS configuration is more flexible, and corresponding subframes, triggered by CSS, used for transmitting paging information will not be restricted to fixed subframes in one radio frame like in LTE and LTE-A. At the same time, in the 5G system, the CSS does not exist in each radio frame either, and multiple CSS configurations with different periodicities probably exist. If all of the subframes or slots for CSS transmission are taken as possible time resources that transmit paging, the researchers find that the calculation of PF and PO based on traditional LTE modes will lead to uneven distribution of the positions of the paging actually transmitted in time domain. This will impact the performance and efficiency of paging.

In view of the above problems, the present disclosure provides a solution. The embodiments in the UE of the present disclosure and the characteristics in the embodiments may be applied to the base station if no conflict is incurred, and vice versa. Further, the embodiments of the present disclosure and the characteristics in the embodiments may be mutually combined if no conflict is incurred.

The present disclosure provides a method in a UE for wireless communication, wherein the method includes:

for K first-type slot sets, detecting a first signaling in only K first-type slot groups therein respectively.

Herein, the K is a positive integer greater than 1; the K first-type slot groups belong to the K first-type slot sets respectively; any one first-type slot set of the K first-type slot sets includes a positive integer number of slots, and any one first-type slot group of the K first-type slot groups includes a positive integer number of slots; the positions of the K first-type slot groups in the K first-type slot sets are different from each other, and the positions of the K first-type slot groups in the K first-type slot sets are all related to an ID of the UE; and the first signaling is used for determining paging related information.

In one embodiment, the above method has the following benefits: the K first-type slot sets correspond to K kinds of different configured periodicities and configured modes for CSS, and the UE searches for the K first-type slot groups in the K first-type slot sets according to different modes respectively, thereby guaranteeing that the paging information of the UE is still evenly distributed in time domain when the UE supports multiple types of CSS configurations.

In one embodiment, the above method has other following benefits: the first-type slot set corresponds to one PF, and the first-type slot group corresponds to the PO in one PF; when the first-type slot group includes 2 or more than 2 slots, compared with the LTE mode, one UE has multiple POs existing in one PF, and thus increasing paging opportunities.

According to one aspect of the present disclosure, the above method includes:

receiving a second signaling.

Herein, the second signaling is used for determining at least one of {K first-type time windows, the K first-type slot sets}, and the K first-type slot sets belongs to the K first-type time windows respectively; and any one first-type time window of the K first-type time windows consists of a positive integer number of consecutive slots.

In one embodiment, the essence of the above method is that: the K first-type time windows correspond to K kinds of different system information respectively, and the K kinds of different system information constitute all the system information monitored by the UE; the K first-type time windows correspond to K kinds of periodicities, and the K first-type time windows together constitute a configured periodicity for CSS.

In one embodiment, the above method has the following benefits: multiple types of different configuration and update modes for system information are introduced, the system flexibility is improved, the situation that each of the UEs needs to monitor all of the time domain positions at which system information is transmitted is avoided, and the complexity of the UE is reduced.

According to one aspect of the present disclosure, the above method includes:

receiving first information.

Herein, the first information and a first ID are used together by the UE to determine the K first-type slot groups from the K first-type slot sets respectively.

In one embodiment, the above method has the following benefits: through the introduction of the first information, a base station configures the first-type slot groups for different first-type slot sets flexibly, and enables the transmission positions of the paging information actually detected by the UE to become more even in time domain, so as to improve the overall performance of the system.

According to one aspect of the present disclosure, the above method is characterized in that: a first parameter and the first ID are used together by the UE to determine the K first-type slot groups from the K first-type slot sets respectively, and the first parameter is randomly generated by the UE.

In one embodiment, the above method has the following benefits: through the introduction of the first parameter randomly generated, the transmission positions of the paging information actually detected by the UE are enabled to become more even in time domain, so as to improve the overall performance of the system.

According to one aspect of the present disclosure, the above method is characterized in that: a second parameter and the first ID are used together by the UE to determine a given first-type slot group from a given first-type slot set; the given first-type slot set is one of the K first-type slot sets, the given first-type slot group is the first-type slot group among the K first-type slot groups that belongs to the given first-type slot set; and the given first-type slot set belongs to a given first-type time window, and the second parameter is related to the given first-type time window.

In one embodiment, the above method has the following benefits: through the introduction of the second parameter related to the first-type time window, the positions of the first-type slot groups in different first-type slot sets are different; thus, the transmission positions of the paging information actually detected by the UE are enabled to become more even in time domain, so as to improve the overall performance of the system.

According to one aspect of the present disclosure, the above method includes:

receiving a first radio signal.

Herein, the first signaling includes configuration information of the first radio signal.

The present disclosure provides a method in a base station for wireless communication, wherein the method includes:

for K first-type slot sets, transmitting a first signaling in only K first-type slot groups therein respectively.

Herein, the K is a positive integer greater than 1; the K first-type slot groups belong to the K first-type slot sets respectively; any one first-type slot set of the K first-type slot sets includes a positive integer number of slots, and any one first-type slot group of the K first-type slot groups includes a positive integer number of slots; the positions of the K first-type slot groups in the K first-type slot sets are different from each other, the positions of the K first-type slot groups in the K first-type slot sets are all related to an ID of a first terminal, and a receiver of the first signaling includes the first terminal; and the first signaling is used for determining paging related information.

According to one aspect of the present disclosure, the above method includes:

transmitting a second signaling.

Herein, the second signaling is used for determining at least one of {K first-type time windows, the K first-type slot sets}, and the K first-type slot sets belongs to the K first-type time windows respectively; and any one first-type time window of the K first-type time windows consists of a positive integer number of consecutive slots.

According to one aspect of the present disclosure, the above method includes:

transmitting first information.

Herein, the first information and a first ID are used together by the first terminal to determine the K first-type slot groups from the K first-type slot sets respectively.

According to one aspect of the present disclosure, the above method is characterized in that: a first parameter and the first ID are used together by the first terminal to determine the K first-type slot groups from the K first-type slot sets respectively; and the first parameter is randomly generated by the first terminal.

According to one aspect of the present disclosure, the above method is characterized in that: a second parameter and the first ID are used together by the first terminal to determine a given first-type slot group from a given first-type slot set, the given first-type slot set is one of the K first-type slot sets, the given first-type slot group is the first-type slot group among the K first-type slot groups that belongs to the given first-type slot set, the given first-type slot set belongs to a given first-type time window, and the second parameter is related to the given first-type time window.

According to one aspect of the present disclosure, the above method includes:

transmitting a first radio signal.

Herein, the first signaling includes configuration information of the first radio signal.

The present disclosure provides a UE for wireless communication, wherein the UE includes:

a first receiver module, to detect a first signaling in only K first-type slot groups in K first-type slot sets respectively.

Herein, the K is a positive integer greater than 1; the K first-type slot groups belong to the K first-type slot sets respectively; any one first-type slot set of the K first-type slot sets includes a positive integer number of slots, and any one first-type slot group of the K first-type slot groups includes a positive integer number of slots; the positions of the K first-type slot groups in the K first-type slot sets are different from each other, and the positions of the K first-type slot groups in the K first-type slot sets are all related to an ID of the UE; and the first signaling is used for determining paging related information;

In one embodiment, the above UE for wireless communication is characterized in that: the first receiver module further receives a second signaling; the second signaling is used for determining at least one of {K first-type time windows, the K first-type slot sets}, and the K first-type slot sets belongs to the K first-type time windows respectively; and any one first-type time window of the K first-type time windows consists of a positive integer number of consecutive slots.

In one embodiment, the above UE for wireless communication is characterized in that: the first receiver module further receives first information; and, the first information and a first ID are used together by the UE to determine the K first-type slot groups from the K first-type slot sets respectively.

In one embodiment, the above UE for wireless communication is characterized in that: a first parameter and the first ID are used together by the UE to determine the K first-type slot groups from the K first-type slot sets respectively; and the first parameter is randomly generated by the UE.

In one embodiment, the above UE for wireless communication is characterized in that: a second parameter and the first ID are used together by the UE to determine a given first-type slot group from a given first-type slot set; the given first-type slot set is one of the K first-type slot sets, the given first-type slot group is the first-type slot group among the K first-type slot groups that belongs to the given first-type slot set; the given first-type slot set belongs to a given first-type time window, and the second parameter is related to the given first-type time window.

In one embodiment, the above UE for wireless communication is characterized in that: the UE further includes a second receiver module, wherein the second receiver module receives a first radio signal; and the first signaling includes configuration information of the first radio signal.

The present disclosure provides a base station device for wireless communication, wherein the base station device includes:

a first transmitter module, to transmit a first signaling in only K first-type slot groups in K first-type slot sets respectively.

Herein, the K is a positive integer greater than 1; the K first-type slot groups belong to the K first-type slot sets respectively; any one first-type slot set of the K first-type slot sets includes a positive integer number of slots, and any one first-type slot group of the K first-type slot groups includes a positive integer number of slots; the positions of the K first-type slot groups in the K first-type slot sets are different from each other, the positions of the K first-type slot groups in the K first-type slot sets are all related to an ID of a first terminal, and a receiver of the first signaling includes the first terminal; and the first signaling is used for determining paging related information.

In one embodiment, the above base station device for wireless communication is characterized in that: the first transmitter module further transmits a second signaling; the second signaling is used for determining at least one of {K first-type time windows, the K first-type slot sets}, and the K first-type slot sets belongs to the K first-type time windows respectively; and any one first-type time window of the K first-type time windows consists of a positive integer number of consecutive slots.

In one embodiment, the above base station device for wireless communication is characterized in that: the first transmitter module further transmits first information; and, the first information and a first ID are used together by the base station device to determine the K first-type slot groups from the K first-type slot sets respectively.

In one embodiment, the above base station device for wireless communication is characterized in that: a first parameter and the first ID are used together by the first terminal to determine the K first-type slot groups from the K first-type slot sets respectively; and the first parameter is randomly generated by the first terminal;

In one embodiment, the above base station device for wireless communication is characterized in that: a second parameter and the first ID are used together by the first terminal to determine a given first-type slot group from a given first-type slot set; the given first-type slot set is one of the K first-type slot sets, the given first-type slot group is the first-type slot group among the K first-type slot groups that belongs to the given first-type slot set; the given first-type slot set belongs to a given first-type time window, and the second parameter is related to the given first-type time window.

In one embodiment, the above base station device for wireless communication is characterized in that: the base station device further includes a second transmitter module, wherein the second transmitter module transmits a first radio signal; and the first signaling includes configuration information of the first radio signal.

In one embodiment, compared with traditional schemes, the present disclosure has the following advantages.

The K first-type slot sets correspond to K kinds of different configured periodicities and configured modes for CSS, and the UE searches for the K first-type slot groups in the K first-type slot sets according to different modes respectively, thereby guaranteeing that the paging information of the UE is still evenly distributed in time domain when the UE supports multiple types of CSS configurations.

The first-type slot set corresponds to a PF, and the first-type slot group corresponds to the PO in one PF; when the first-type slot group includes 2 or more than 2 slots, compared with the LTE mode, one UE has multiple POs existing in one PF, and thus has the paging occasion increased.

Through the introduction of one of {the first information, the first parameter, the second parameter}, the transmission positions of the paging information actually detected by the UE are enabled to become more even in time domain, so as to improve the overall performance of the system.

### BRIEF DESCRIPTION OF THE DRAWINGS

Other features, purposes and advantages of the present disclosure will become more apparent from the detailed description of non-restrictive embodiments taken in conjunction with the following drawings.

FIG. 1 is a flowchart of a first signaling according to one embodiment of the present disclosure.

FIG. 2 is a diagram illustrating a network architecture according to one embodiment of the present disclosure.

FIG. 3 is a diagram illustrating an embodiment of a radio protocol architecture of a user plane and a control plane according to one embodiment of the present disclosure.

FIG. 4 is a diagram illustrating an evolved node B and a UE according to one embodiment of the present disclosure.

FIG. 5 is a flowchart of a second signaling according to one embodiment of the present disclosure.

FIG. 6 is a diagram illustrating K first-type slot sets and K first-type slot groups according to one embodiment of the present disclosure.

FIG. 7 is a diagram illustrating K first-type slot sets and K first-type slot groups according to another embodiment of the present disclosure.

FIG. 8 is a diagram illustrating a given first-type time window, a given first-type slot set and a given first-type slot group according to one embodiment of the present disclosure.

FIG. 9 is a diagram illustrating a given first-type time window, a given first-type slot set and a given first-type slot group according to another embodiment of the present disclosure.

FIG. 10 is a structure block diagram illustrating a processing device in a UE according to one embodiment of the present disclosure.

FIG. 11 is a structure block diagram illustrating a processing device in a base station according to one embodiment of the present disclosure.

### DESCRIPTION OF THE EMBODIMENTS

The technical scheme of the present disclosure is described below in further details in conjunction with the drawings. It should be noted that the embodiments in the present disclosure and the characteristics of the embodiments may be arbitrarily combined if no conflict is caused.

### Embodiment 1

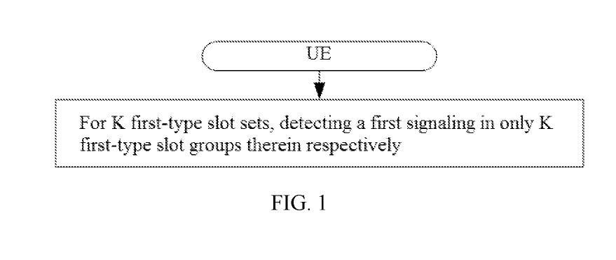

Embodiment 1 illustrates an example of a flowchart of a first signaling, as shown in FIG. 1.

In Embodiment 1, the UE in the present disclosure detects a first signaling in only K first-type slot groups in K first-type slot sets respectively; the K is a positive integer greater than 1; the K first-type slot groups belong to the K first-type slot sets respectively; any one first-type slot set of the K first-type slot sets includes a positive integer number of slots, and any one first-type slot group of the K first-type slot groups includes a positive integer number of slots; the positions of the K first-type slot groups in the K first-type slot sets are different from each other, and the positions of the K first-type slot groups in the K first-type slot sets are all related to an ID of the UE; and the first signaling is used for determining paging related information.

In one subembodiment, the slot refers to a time slot.

In one subembodiment, the duration of the slot in time domain is not greater than 1 ms.

In one subembodiment, the duration of the slot in time domain is 1 ms.

In one subembodiment, the slot includes N consecutive multicarrier symbols in time domain, wherein the N is one of {7, 14}.

In one subembodiment, the multicarrier symbol in the present disclosure is one of {Orthogonal Frequency Division Multiplexing (OFDM) symbol, Single-Carrier Frequency Division Multiple Access (SC-FDMA) symbol, Filter Bank Multi Carrier (FBMC) symbol, OFDM symbol including Cyclic Prefix (CP), Discrete Fourier Transform-Spreading-OFDM (DFT-s-OFDM) symbol including CP}.

In one subembodiment, the first signaling is a physical layer downlink control signaling, and a Cyclic Redundancy Check (CRC) included in the physical layer downlink control signaling is scrambled by a Paging Radio Network Temporary Identity (P-RNTI).

In one affiliated embodiment of the above subembodiment, a physical layer channel corresponding to the physical layer downlink control signaling is one of {Physical Downlink Control Channel (PDCCH), New Radio Access Technology PDCCH (NR-PDCCH), Short-Latency PDCCH (SPDCCH)}.

In one subembodiment, a transmission channel corresponding to the paging related information is a Paging Channel (PCH).

In one subembodiment, the paging related information includes at least one of {paging record, whether system information changes, whether to receive information from earthquake & tsunami warning systems, whether to receive information from commercial mobile alarm services, whether to transmit beam reports}.

In one subembodiment, the first-type slot set is a PF.

In one subembodiment, the first-type slot set includes a positive integer number of consecutive slots.

In one subembodiment, the first-type slot set is related to Discontinuous Reception (DRX) configuration information of the UE; or, the first-type slot set is related to Extended Discontinuous Reception (eDRX) configuration information of the UE.

In one affiliated embodiment of the above subembodiment, the DRX configuration information belongs to PCCH-Config Information Elements (PCCH-Config IE) in TS 36.331.

In one subembodiment, the first-type slot group represents M1 POs included in the corresponding first-type slot set, wherein the M1 is equal to 1, or the M1 is a positive integer greater than 1.

In one subembodiment, the first-type slot group includes M slots, wherein M is a positive integer greater than 1.

In one subembodiment, the first-type slot group includes 1 slot only.

In one subembodiment, the positions of the K first-type slot groups in the K first-type slot sets being different from each other refers that: the K first-type slot groups correspond to a first-type slot group #1 to a first-type slot group #K respectively, the first-type slot group #1 to the first-type slot group #K belong to a first-type slot set #1 to a first-type slot set #K respectively; for i and j, the position of the first-type slot group #i in the first-type slot set #i is not equal to the position of the first-type slot group #j in the first-type slot set #j, wherein the i is not equal to the j, and the i and j both are any positive integers not less than 1 but not greater than K.

In one subembodiment, the positions of the K first-type slot groups in the K first-type slot sets being different from each other refers that: the K is equal to 2, the K first-type slot groups correspond to a first slot group and a second slot group respectively, the first slot group and the second slot group belong to a first slot set and a second slot set respectively; the position of the first slot group in the first slot set is not equal to the position of the second slot group in the second slot set.

In one subembodiment, there are L second-type slot sets, and the UE detects the first signaling in only L second-type slot groups therein respectively, wherein the L is a positive integer greater than 1; the L second-type slot groups belong to the L second-type slot sets respectively; any one second-type slot set of the L second-type slot sets includes a positive integer number of slots, and any one slot group of the L slot groups includes a positive integer number of slots; the positions of the L second-type slot groups in the L second-type slot sets are the same, and the positions of the L second-type slot groups in the L second-type slot sets are all related to an ID of the UE; and the first signaling is used for determining paging related information.

In one subembodiment, any two first-type slot sets of the K first-type slot sets include the same number of slots.

In one subembodiment, the K first-type slot sets include at least two first-type slot sets, and the two first-type slot sets include different numbers of slots.

In one subembodiment, there is no slot that belongs to any two first-type slot sets of the K first-type slot sets simultaneously.

In one subembodiment, the ID of the UE consists of 16 bits.

In one subembodiment, the ID of the UE is an International Mobile Subscriber Identification Number (IMSI) of the UE.

In one subembodiment, the ID of the UE is an SAE Temporary Mobile Subscriber Identity (S-TMSI) of the UE, wherein the SAE refers to System Architecture Evolution.

In one affiliated embodiment of the above two subembodiments, a first integer is equal to a remainder of the ID of the UE modulo 1024, and the first integer is used for determining the positions of the K first-type slot groups in the K first-type slot sets.

In an example of the above affiliated embodiment, the first integer is further used for determining the positions of the K first-type slot groups.

In one subembodiment, the K first-type slot sets are reserved for CSS.

In one subembodiment, each of the K first-type slot sets includes CSS for the UE.

In one subembodiment, the K first-type slot sets are used to transmit at least one of {Synchronization Sequence Block (SSB), Physical Broadcast Channel (PBCH), Remaining System Information (RMSI)}.

In one affiliated embodiment of the above subembodiment, the K first-type slot sets being used to transmit at least one of {SSB, PBCH, RMSI} refers that: the K first-type slot sets include at least one slot that is used to transmit at least one of {SSB, PBCH, RMSI}.

In one subembodiment, the position in the present disclosure includes an absolute position in time domain.

In one affiliated embodiment of the above subembodiment, the absolute position in time domain refers that: a target first-type slot group includes P1 slots, the target first-type slot group belongs to a target first-type slot set, and the target first-type slot set includes P2 consecutive slots; the absolute position in time domain refers to the indexes of the P1 slots in the P2 slots; wherein the P2 is greater than the P1, and both the P1 and P2 are positive integers.

In one subembodiment, the position in the present disclosure includes a relative position in time domain.

In one affiliated embodiment of the above subembodiment, the relative position in time domain refers that: a target first-type slot group includes P1 slots, the target first-type slot group belongs to a target first-type slot set, the target first-type slot set includes P2 slots, and the P2 slots are reserved for CSS; the absolute position in time domain refers to the indexes of the P1 slots in the P2 slots; wherein the P2 is greater than the P1, and both the P1 and P2 are positive integers.

### Embodiment 2

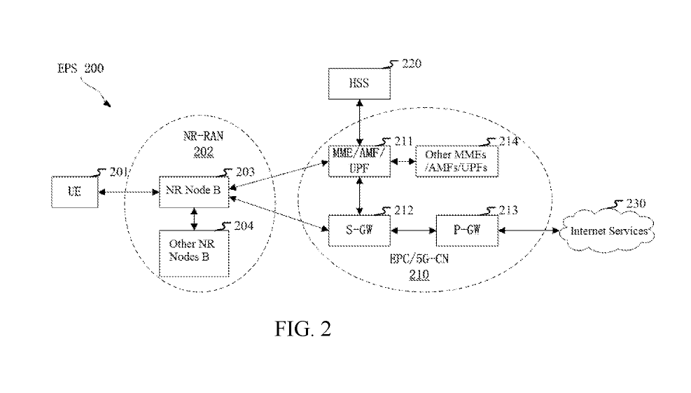

Embodiment 2 illustrates an example of a diagram of a network architecture, as shown in FIG. 2.

Embodiment 2 illustrates an example of a diagram of a network architecture according to the present disclosure, as shown in FIG. 2. FIG. 2 is a diagram illustrating a network architecture 200 of NR 5G, Long-Term Evolution (LTE), Long-Term Evolution Advanced (LTE-A) systems. The NR 5G or LTE network architecture 200 may be called an Evolved Packet System (EPS) 200 or some other appropriate terms. The EPS 200 may include one or more UEs 201, an NG-RAN 202, an Evolved Packet Core/5G-Core Network (EPC/5G-CN) 210, a Home Subscriber Server (HSS) 220 and an Internet Service 230. Herein, the EPS may be interconnected with other access networks. For simple description, the entities/interfaces are not shown. As shown in FIG. 2, the EPS provides packet switching services. Those skilled in the art are easy to understand that various concepts presented throughout the present disclosure can be extended to networks providing circuit switching services or other cellular networks. The NG-RAN includes an NR node B (gNB) 203 and other gNBs 204. The gNB 203 provides UE 201 oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Basic Service Set (BSS), an Extended Service Set (ESS), a Transmitter Receiver Point (TRP) or some other appropriate terms. The gNB 203 provides an access point of the EPC/5G-CN 210 for the UE 201. Examples of UE 201 include cellular phones, smart phones, Session Initiation Protocol (SIP) phones, laptop computers, Personal Digital Assistants (PDAs), Satellite Radios, non-ground base station communications, satellite mobile communications, Global Positioning Systems (GPSs), multimedia devices, video devices, digital audio player (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 includes a Mobility Management Entity/Authentication Management Field/User Plane Function (MME/AMF/UPF) 211, other MMEs/AMFs/UPFs 214, a Service Gateway (S-GW) 212 and a Packet Data Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212. The S-GW 212 is connected to the P-GW 213. The P-GW 213 provides UE IP address allocation and other functions. The P-GW 213 is connected to the Internet service 230. The Internet service 230 includes IP services corresponding to operators, specifically including Internet, Intranet, IP Multimedia Subsystems (IMSs) and Packet Switching Streaming Services (PSSs).

In one subembodiment, the UE 201 corresponds to the UE in the present disclosure.

In one subembodiment, the gNB 203 corresponds to the base station in the present disclosure.

In one subembodiment, the UE 201 supports wireless communications of multiple types of CSS configurations.

In one subembodiment, the gNB 203 supports wireless communications of multiple types of CSS configurations.

In one subembodiment, the UE 201 supports wireless communications of multiple paging schemes.

In one subembodiment, the gNB 203 supports wireless communications of multiple paging schemes.

### Embodiment 3

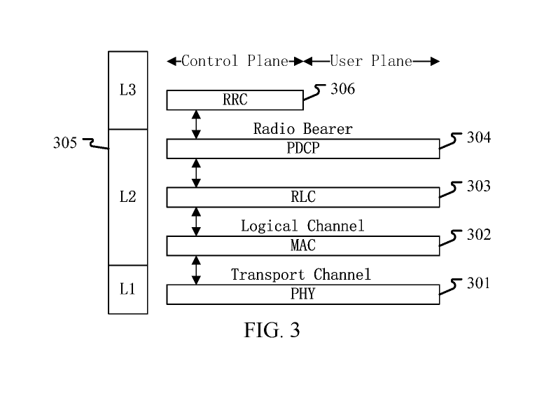

Embodiment 3 illustrates a diagram of an embodiment of a radio protocol architecture of a user plane and a control plane according to the present disclosure, as shown in FIG. 3.

FIG. 3 is a diagram illustrating an embodiment of a radio protocol architecture of a user plane and a control plane. In FIG. 3, the radio protocol architecture of a UE and a base station device (gNB or eNB) is represented by three layers, which are a layer 1, a layer 2 and a layer 3 respectively. The layer 1 (L1) is the lowest layer and performs signal processing functions of various PHY layers. The layer 1 is called PHY 301 in this paper. The layer 2 (L2) 305 is above the PHY 301, and is in charge of the link between the UE and the gNB via the PHY 301. In the user plane, the L2 305 includes a Medium Access Control (MAC) sublayer 302, a Radio Link Control (RLC) sublayer 303, and a Packet Data Convergence Protocol (PDCP) sublayer 304. All the three sublayers terminate at the gNB of the network side. Although not described in FIG. 3, the UE may include several higher layers above the L2 305, such as a network layer (i.e. IP layer) terminated at a P-GW of the network side and an application layer terminated at the other side of the connection (i.e. a peer UE, a server, etc.). The PDCP sublayer 304 provides multiplexing among variable radio bearers and logical channels. The PDCP sublayer 304 also provides a header compression for a higher-layer packet so as to reduce a radio transmission overhead. The PDCP sublayer 304 provides security by encrypting a packet and provides support for UE handover between gNBs. The RLC sublayer 303 provides segmentation and reassembling of a higher-layer packet, retransmission of a lost packet, and reordering of a packet to as to compensate the disordered receiving caused by Hybrid Automatic Repeat Request (HARQ). The MAC sublayer 302 provides multiplexing between logical channels and transport channels. The MAC sublayer 302 is also responsible for allocating between UEs various radio resources (i.e., resource block) in a cell. The MAC sublayer 302 is also in charge of HARQ operation. In the control plane, the radio protocol architecture of the UE and the gNB is almost the same as the radio protocol architecture in the user plane on the PHY 301 and the L2 305, but there is no header compression for the control plane. The control plane also includes a Radio Resource Control (RRC) sublayer 306 in the layer 3 (L3). The RRC sublayer 306 is responsible for acquiring radio resources (i.e. radio bearer) and configuring the lower layers using an RRC signaling between the gNB and the UE.

In one subembodiment, the radio protocol architecture in FIG. 3 is applicable to the UE in the present disclosure.

In one subembodiment, the radio protocol architecture in FIG. 3 is applicable to the base station in the present disclosure.

In one subembodiment, the first signaling in the present disclosure is generated by the PHY 301.

In one subembodiment, the second signaling in the present disclosure is generated by one of {the RRC sublayer 306, the MAC sublayer 302}.

In one subembodiment, the first information in the present disclosure is generated by one of {the RRC sublayer 306, the MAC sublayer 302}.

### Embodiment 4

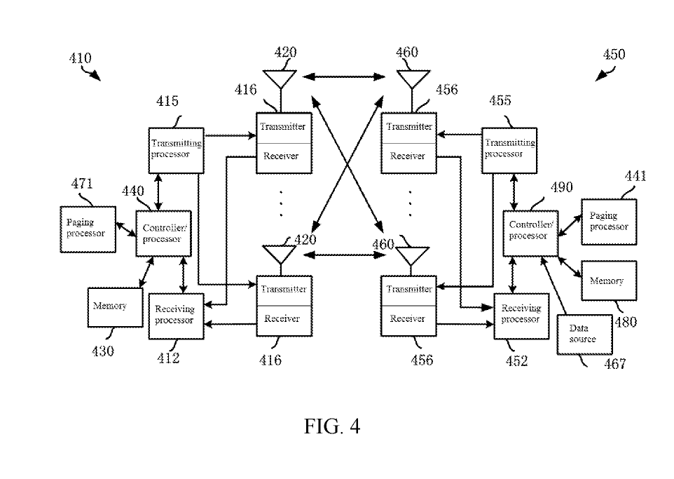

Embodiment 4 illustrates a diagram of a base station device and a UE according to the present disclosure, as shown in FIG. 4. FIG. 4 is a block diagram of a gNB 410 in communication with a UE 450 in an access network.

The base station device 410 includes a controller/processor 440, a memory 430, a receiving processor 412, a transmitting processor 415, a paging processor 471, a transmitter/receiver 416 and an antenna 420.

The UE 450 includes a controller/processor 490, a memory 480, a data source 467, a transmitting processor 455, a receiving processor 452, a paging processor 441, a transmitter/receiver 456 and an antenna 460.

In Downlink (DL) transmission, processes relevant to the base station device 410 include the following.

A packet from a higher layer is provided to the controller/processor 440. The controller/processor 440 provides header compression, encryption, packet segmentation and reordering, multiplexing and de-multiplexing between a logical channel and a transport channel, to implement the L2 protocol used for the user plane and the control plane. The packet from a higher layer may include data or control information, for example, Downlink Shared Channel (DL-SCH).

The controller/processor 440 is connected to the memory 430 that stores program codes and data. The memory 430 may be a computer readable medium.

The controller/processor 440 includes a scheduling unit for a transmission requirement, and the scheduling unit is configured to schedule an aerial resource corresponding to the transmission requirement.

The paging processor 471 determines to transmit a first signaling in only K first-type slot groups in K first-type slot sets respectively and determines a second signaling and first information, and then transmits the result to the controller/processor 440.

The transmitting processor 415 receives a bit stream output from the controller/processor 440, and performs signal transmitting processing functions of an L1 layer (that is, PHY), including encoding, interleaving, scrambling, modulation, power control/allocation, generation of physical layer control signaling (including PBCH, PDCCH, PHICH, PCFICH, reference signal), etc.

The transmitter 416 is configured to convert the baseband signal provided by the transmitting processor 415 into a radio-frequency signal and transmit the radio-frequency signal via the antenna 420. Each transmitter 416 performs sampling processing on respective input symbol streams to obtain respective sampled signal streams. Each transmitter 416 performs further processing (for example, digital-to-analogue conversion, amplification, filtering, up conversion, etc.) on respective sampled streams to obtain a downlink signal.

In DL transmission, processes relevant to the UE 450 include the following.

The receiver 456 is configured to convert a radio-frequency signal received via the antenna 460 into a baseband signal and provide the baseband signal to the receiving processor 452.

The receiving processor 452 performs signal receiving processing functions of an L1 layer (that is, PHY), including decoding, de-interleaving, descrambling, demodulation, extraction of physical layer control signaling, etc.

The paging processor 441 determines to detect a first signaling in only K first-type slot groups in K first-type slot sets respectively, and transmits the result to the controller/processor 490.

The controller/processor 490 receives a bit stream output from the receiving processor 452, and provides header decompression, decryption, packet segmentation and reordering, multiplexing and de-multiplexing between a logical channel and a transport channel, to implement the L2 protocol used for the user plane and the control plane.

The controller/processor 490 is connected to the memory 480 that stores program codes and data. The memory 480 may be a computer readable medium.

In one subembodiment, the UE 450 device includes at least one processor and at least one memory. The at least one memory includes computer program codes. The at least one memory and the computer program codes are configured to be used in collaboration with the at least one processor. The UE 450 at least detects a first signaling in only K first-type slot groups in K first-type slot sets respectively; the K is a positive integer greater than 1; the K first-type slot groups belong to the K first-type slot sets respectively; any one first-type slot set of the K first-type slot sets includes a positive integer number of slots, and any one first-type slot group of the K first-type slot groups includes a positive integer number of slots; the positions of the K first-type slot groups in the K first-type slot sets are different from each other, and the positions of the K first-type slot groups in the K first-type slot sets are all related to an ID of the UE; and the first signaling is used for determining paging related information.

In one subembodiment, the UE 450 includes a memory that stores a computer readable instruction program. The computer readable instruction program generates an action when executed by at least one processor. The action includes: for K first-type slot sets, detecting a first signaling in only K first-type slot groups therein respectively; the K is a positive integer greater than 1; the K first-type slot groups belong to the K first-type slot sets respectively; any one first-type slot set of the K first-type slot sets includes a positive integer number of slots, and any one first-type slot group of the K first-type slot groups includes a positive integer number of slots; the positions of the K first-type slot groups in the K first-type slot sets are different from each other, and the positions of the K first-type slot groups in the K first-type slot sets are all related to an ID of the UE; and the first signaling is used for determining paging related information.

In one subembodiment, the gNB 410 device includes at least one processor and at least one memory. The at least one memory includes computer program codes. The at least one memory and the computer program codes are configured to be used in collaboration with the at least one processor. The gNB 410 at least transmits a first signaling in only K first-type slot groups in K first-type slot sets respectively; the K is a positive integer greater than 1; the K first-type slot groups belong to the K first-type slot sets respectively; any one first-type slot set of the K first-type slot sets includes a positive integer number of slots, and any one first-type slot group of the K first-type slot groups includes a positive integer number of slots; the positions of the K first-type slot groups in the K first-type slot sets are different from each other, the positions of the K first-type slot groups in the K first-type slot sets are all related to an ID of a first terminal, and a receiver of the first signaling includes the first terminal; and the first signaling is used for determining paging related information.

In one subembodiment, the gNB 410 includes a memory that stores a computer readable instruction program. The computer readable instruction program generates an action when executed by at least one processor. The action includes: for K first-type slot sets, transmitting a first signaling in only K first-type slot groups therein respectively; the K is a positive integer greater than 1; the K first-type slot groups belong to the K first-type slot sets respectively; any one first-type slot set of the K first-type slot sets includes a positive integer number of slots, and any one first-type slot group of the K first-type slot groups includes a positive integer number of slots; the positions of the K first-type slot groups in the K first-type slot sets are different from each other, the positions of the K first-type slot groups in the K first-type slot sets are all related to an ID of a first terminal, and a receiver of the first signaling includes the first terminal; and the first signaling is used for determining paging related information.

In one subembodiment, the UE 450 corresponds to the UE in the present disclosure.

In one subembodiment, the gNB 410 corresponds to the base station in the present disclosure.

In one subembodiment, at least the former two of the receiver 456, the receiving processor 452, and the controller/processor 490 are used for detecting a first signaling in only K first-type slot groups in K first-type slot sets respectively.

In one subembodiment, at least the former two of the receiver 456, the receiving processor 452, and the controller/processor 490 are used for receiving a second signaling.

In one subembodiment, at least the former two of the receiver 456, the receiving processor 452, and the controller/processor 490 are used for receiving first information.

In one subembodiment, at least the former two of the receiver 456, the receiving processor 452, and the controller/processor 490 are used for receiving a first radio signal.

In one subembodiment, the paging processor 441 is used for detecting a first signaling in only K first-type slot groups in K first-type slot sets respectively.

In one subembodiment, at least the former two of the transmitter 416, the transmitting processor 415, and the controller/processor 440 are used for transmitting a first signaling in only K first-type slot groups in K first-type slot sets respectively.

In one subembodiment, at least the former two of the transmitter 416, the transmitting processor 415, and the controller/processor 440 are used for transmitting a second signaling.

In one subembodiment, at least the former two of the transmitter 416, the transmitting processor 415, and the controller/processor 440 are used for transmitting first information.

In one subembodiment, at least the former two of the transmitter 416, the transmitting processor 415, and the controller/processor 440 are used for transmitting a first radio signal.

In one subembodiment, the paging processor 471 is used for determining to transmit a first signaling in only K first-type slot groups in K first-type slot sets respectively.

In one subembodiment, the paging processor 471 is used for determining a second signaling.

In one subembodiment, the paging processor 471 is used for determining first information.

### Embodiment 5

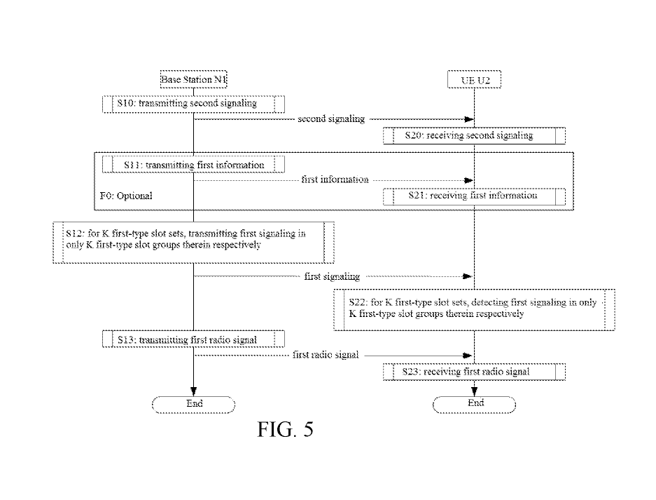

Embodiment 5 illustrates an example of a flowchart of a second signaling, as shown in FIG. 5. In FIG. 5, the base station N1 is a maintenance base station for a serving cell of the UE U2, and the steps shown in box F0 are optional.

The base station N1 transmits a second signaling in S10, transmits first information in S11, transmits a first signaling in only K first-type slot groups in K first-type slot sets respectively in S12, and transmits a first radio signal in S13.

The UE U2 receives a second signaling in S20, receives first information in S21, detects a first signaling in only K first-type slot groups in K first-type slot sets respectively in S22, and receives a first radio signal in S23.

In Embodiment 5, the K is a positive integer greater than 1; the K first-type slot groups belong to the K first-type slot sets respectively; any one first-type slot set of the K first-type slot sets includes a positive integer number of slots, and any one first-type slot group of the K first-type slot groups includes a positive integer number of slots; the positions of the K first-type slot groups in the K first-type slot sets are different from each other, and the positions of the K first-type slot groups in the K first-type slot sets are all related to an ID of the UE; the first signaling is used for determining paging related information; the second signaling is used for determining at least one of {K first-type time windows, the K first-type slot sets}, and the K first-type slot sets belongs to the K first-type time windows respectively; and any one first-type time window of the K first-type time windows consists of a positive integer number of consecutive slots; the first information and a first ID are used together by the UE to determine the K first-type slot groups from the K first-type slot sets respectively; and the first signaling includes configuration information of the first radio signal.

In one subembodiment, any two first-type time windows of the K first-type time windows include the same number of slots.

In one affiliated embodiment of the above subembodiment, any two first-type time windows of the K first-type time windows are orthogonal in time domain.

In one affiliated embodiment of the above subembodiment, the K first-type time windows are consecutive in time domain.

In one affiliated embodiment of the above subembodiment, the K first-type time windows constitute a configured periodicity for CSS.

In one subembodiment, at least two first-type time windows of the K first-type time windows include different numbers of slots.

In one affiliated embodiment of the above subembodiment, there is at least one slot that belongs to two first-type time windows of the K first-type time windows simultaneously.

In one subembodiment, at least one first-type time window of the K first-type time windows includes slots that are a subset of the slots included in another first-type time window.

In one affiliated embodiment of the above subembodiment, the K first-type time windows have one and only one first-type time window that is a configured periodicity for CSS.

In one subembodiment, a given first-type slot set includes T1 consecutive slots, the given first-type slot set belongs to a given first-type time window, and the given first-type time window includes T2 consecutive slots, wherein the T2 is a positive integer multiple of the T1.

In one subembodiment, the K first-type time windows correspond to K kinds of service types respectively.

In one affiliated embodiment of the above subembodiment, the K kinds of service types correspond to K different types of system information respectively.

In one subembodiment, the first information includes K first sub-information groups, and the K first sub-information groups are one to one corresponding to the K first-type slot sets.

In one affiliated embodiment of the above subembodiment, a given first sub-information group is any one of the K first sub-information groups, the given first sub-information group corresponds to a given first-type slot set, the given first-type slot set corresponds to a given first-type slot group, the given first sub-information group and the first ID are used by the UE to determine the given first-type slot group from the given first-type slot set; the given first-type slot group is the first-type slot group among the K first-type slot groups that belongs to the given first-type slot set; and the given first-type slot set is the first-type slot set among the K first-type slot sets that corresponds to the given first sub-information group.

In one example of the above affiliated embodiment, the given first sub-information group includes a positive integer T₁, wherein the T₁ is a configured periodicity for CSS corresponding to the given first-type slot set; a positive integer T is a DRX periodicity of the UE, or the positive integer T is an eDRX periodicity of the UE, specifically referring to T in TS 36.304; a lowest common multiple of the T₁ and the T is T₂; and the position of the given first-type slot set in time domain meets the following formula.

STN mod(T₂)=(T₂ div N)*(UE_ID mod N)

where the STN refers to System Time-window Number; the System Time-window (ST) includes a positive integer number of consecutive slots, or the ST includes a positive integer number of consecutive subframes; the given first-type slot set includes a positive integer number of consecutive STs; the N is equal to min(T₂, nB); the nB refers to the nB in TS 36.304; (X div Y) refers to rounding a quotient of X divided by Y, and (X mod Y) refers to calculating a remainder of X divided by Y; and the UE_ID refers to the first integer in the present disclosure.

In a special case of the above example, the STN corresponds to an SFN in LTE.

In a special case of the above example, the ST corresponds to a system frame in LTE.

In a special case of the above example, the time domain position of the given first-type slot group in the given first-type slot set meets the following formula.

i_s=floor(UE_ID/N)mod N_{S}

where N_{S} is equal to max(1, nB/T₂), the i_s and the N_{S} can refer to the relationship in the following table.

| | PO when | PO when | PO when | PO when |
|---|---|---|---|---|
| Ns | i_s = 0 | i_s = 1 | i_s = 2 | i_s = 4 |
| 1 | I_4 | N/A | N/A | N/A |
| 2 | I_2 | I_4 | N/A | N/A |
| 4 | I_1 | I_2 | I_3 | I_4 |

The I_1, I_2, I_3 and I_4 in the table represent respectively the indexes of the slots used for paging transmission in a given first-type slot set, wherein the slots are included in the given first-type slot set; and the I_1, I_2, I_3 and I_4 are all non-negative positive integers.

In one example of the special case, the given first sub-information group indicates the {I_1, I_2, I_3 and I_4}.

In one example of the special case, the {I_1, I_2, I_3 and I_4} is related to the given first-type slot set.

In one subembodiment, a first parameter and the first ID are used together by the UE to determine the K first-type slot groups from the K first-type slot sets respectively, and the first parameter is randomly generated by the UE.

In one affiliated embodiment of the above subembodiment, the first parameter is F₁, the F₁ being a non-negative integer, T₁ is a configured periodicity for CSS corresponding to the given first-type slot set, and the given first-type slot set is one of the K first-type slot sets; a positive integer T is a DRX periodicity of the UE, or the positive integer T is an eDRX periodicity of the UE, specifically referring to T in TS 36.304; a lowest common multiple of the T₁ and the T is T₂; and the position of the given first-type slot set in time domain meets the following formula.

STN mod(T₂)=(T₂ div N)*(UE_ID mod N)

where the STN refers to System Time-window Number; the ST includes a positive integer number of consecutive slots, or the ST includes a positive integer number of consecutive subframes; the given first-type slot set includes a positive integer number of consecutive STs; the N is equal to min(T₂, nB); the nB refers to the nB in TS 36.304; (X div Y) refers to rounding a quotient of X divided by Y, and (X mod Y) refers to calculating a remainder of X divided by Y; and the UE_ID refers to the first integer in the present disclosure.

In one example of the above affiliated embodiment, the STN corresponds to an SFN in LTE.

In one example of the above affiliated embodiment, the ST corresponds to a system frame in LTE.

In one example of the above affiliated embodiment, the time domain position of the given first-type slot group, which is corresponding to the given first-type slot set, in the first-type slot set meets the following formula, wherein the given first-type slot group is the first-type slot group among the K first-type slot groups that corresponds to the given first-type slot set:

i_s={[floor(UE_ID/N)]+F₁} mod N_{S}

where N_{S} is equal to max(1, nB/T₂), the i_s and the N_{S} can refer to the relationship in the following table.

| | PO when | PO when | PO when | PO when |
|---|---|---|---|---|
| Ns | i_s = 0 | i_s = 1 | i_s = 2 | i_s = 4 |
| 1 | I_4 | N/A | N/A | N/A |
| 2 | I_2 | I_4 | N/A | N/A |
| 4 | I_1 | I_2 | I_3 | I_4 |

The I_1, I_2, I_3 and I_4 in the table represent respectively the indexes of the slots used for paging transmission in a given first-type slot set, wherein the slots are included in the given first-type slot set; and the I_1, I_2, I_3 and I_4 are all non-negative positive integers.

In one subembodiment, a second parameter and the first ID are used together by the UE to determine a given first-type slot group from a given first-type slot set, the given first-type slot set is one of the K first-type slot sets, the given first-type slot group is the first-type slot group among the K first-type slot groups that belongs to the given first-type slot set, the given first-type slot set belongs to a given first-type time window, and the second parameter is related to the given first-type time window.

In one affiliated embodiment of the above subembodiment, the second parameter is F₂, the F₂ being a non-negative integer, T₁ is a configured periodicity for CSS corresponding to the given first-type slot set; a positive integer T is a DRX periodicity of the UE, or the positive integer T is an eDRX periodicity of the UE, specifically referring to T in TS 36.304; a lowest common multiple of the T₁ and the T is T₂; and the position of the given first-type slot set in time domain meets the following formula.

STN mod(T₂)=(T₂ div N)*(UE_ID mod N)

where the STN refers to System Time-window Number; the ST includes a positive integer number of consecutive slots, or the ST includes a positive integer number of consecutive subframes; the given first-type slot set includes a positive integer number of consecutive STs; the N is equal to min(T₂, nB); the nB refers to the nB in TS 36.304; (X div Y) refers to rounding a quotient of X divided by Y, and (X mod Y) refers to calculating a remainder of X divided by Y; and the UE_ID refers to the first integer in the present disclosure.

In one example of the above affiliated embodiment, the STN corresponds to an SFN in LTE.

In one example of the above affiliated embodiment, the ST corresponds to a system frame in LTE.

In one example of the above affiliated embodiment, the time domain position of the given first-type slot group, which is corresponding to the given first-type slot set, in the given first-type slot set meets the following formula:

i_s={[floor(UE_ID/N)]+F₂} mod N_{S}

where N_{S} is equal to max(1, nB/T₂), the i_s and the N_{S} can refer to the relationship in the following table.

| | PO when | PO when | PO when | PO when |
|---|---|---|---|---|
| Ns | i_s = 0 | i_s = 1 | i_s = 2 | i_s = 4 |
| 1 | I_4 | N/A | N/A | N/A |
| 2 | I_2 | I_4 | N/A | N/A |
| 4 | I_1 | I_2 | I_3 | I_4 |

The I_1, I_2, I_3 and I_4 in the table represent respectively the indexes of the slots used for paging transmission in a given first-type slot set, wherein the slots are included in the given first-type slot set; and the I_1, I_2, I_3 and I_4 are all non-negative positive integers.

In one subembodiment, the configuration information includes at least one of {position of occupied time domain resources, position of occupied frequency domain resources, corresponding transmitting antenna port, corresponding receiving antenna port, Modulation and Coding Status (MCS), Redundancy Version (RV), New Data Indicator (NDI), HARQ procedure number}.

In one subembodiment, a transmission channel corresponding to the first radio signal is a PCH.

In one subembodiment, a physical channel corresponding to the first radio signal is one of {Physical Downlink Shared Channel (PDSCH), New Radio Access Technology PDSCH (NR-PDSCH), Short-Latency Radio Access Technology PDSCH (SPDSCH)}.

### Embodiment 6

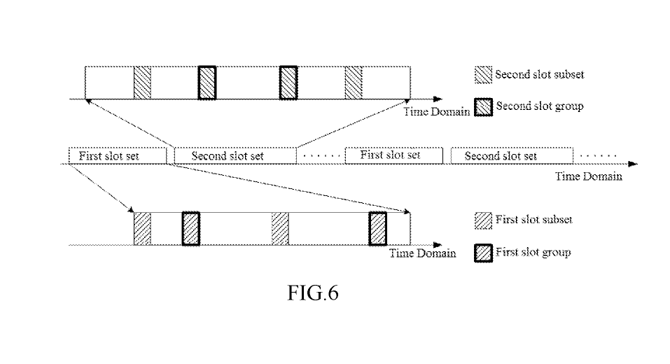

Embodiment 6 illustrates an example of a diagram of K first-type slot sets and K first-type slot groups, as shown in FIG. 6.

In FIG. 6, K first-type slot sets at least include a first slot set and a second slot set, the first slot set includes N1 consecutive slots, and the second slot set includes N2 consecutive slots; the first slot set includes a first slot subset, and the first slot subset includes the first slot group in the present disclosure; the second slot set includes a second slot subset, and the second slot subset includes the second slot group in the present disclosure; at least one of the first slot group and the second slot group includes not less than 2 slots.

In one subembodiment, adjacent first slot sets correspond to a configured periodicity for CSS for one service.

In one subembodiment, the K first-type slot sets constitute all CSS configuration periodicities for the UE in the present disclosure.

In one subembodiment, other UEs that use the same DRX as the UE in the present disclosure search for paging related information in the first slot subset and the second slot subset.

In one subembodiment, the UE in the present disclosure searches for paging related information in the first slot group and the second slot group.

In one subembodiment, the first slot subset and the second slot subset are used for CSS transmission.

### Embodiment 7

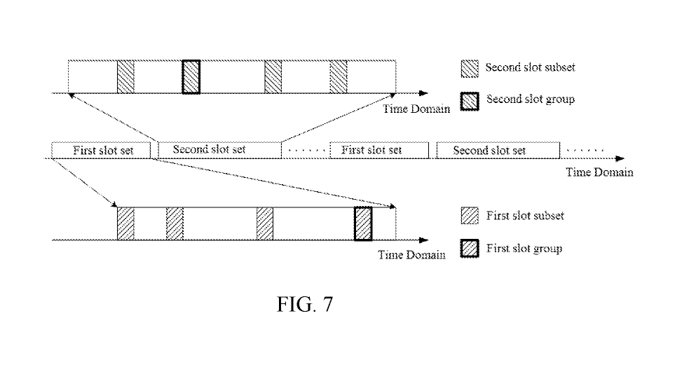

Embodiment 7 illustrates another example of a diagram of K first-type slot sets and K first-type slot groups, as shown in FIG. 7.

In FIG. 7, K first-type slot sets include a first slot set and a second slot set, the first slot set includes N1 consecutive slots, and the second slot set includes N2 consecutive slots; the first slot set includes a first slot subset, and the first slot subset includes the first slot group in the present disclosure; the second slot set includes a second slot subset, and the second slot subset includes the second slot group in the present disclosure; and both the first slot group and the second slot group include only one slot.

In one subembodiment, adjacent first slot sets correspond to a configured periodicity for CSS for one service.

In one subembodiment, the K first-type slot sets constitute all CSS configuration periodicities for the UE in the present disclosure.

In one subembodiment, UEs that use the same DRX as the UE in the present disclosure search for paging related information in the first slot subset and the second slot subset.

In one subembodiment, the UE in the present disclosure searches for paging related information in the first slot group and the second slot group.

In one subembodiment, the first slot subset and the second slot subset are used for CSS transmission.

### Embodiment 8

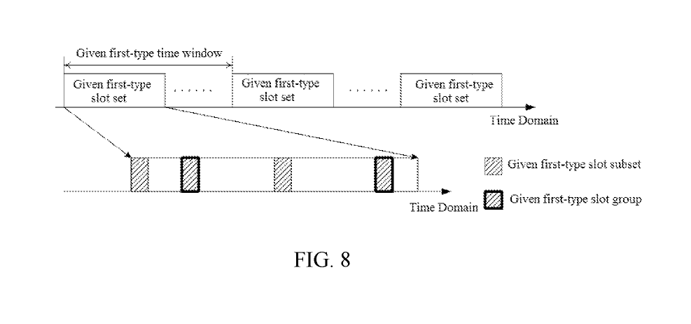

Embodiment 8 illustrates an example of a diagram of a given first-type time window, a given first-type slot set and a given first-type slot group, as shown in FIG. 8. In FIG. 8, the given first-type slot set is any one of the K first-type slot sets in the present disclosure, and the given first-type slot group is the first-type slot group among the K first-type slot groups that belongs to the given first-type slot set; a periodicity between two given first-type slot sets adjacent in time domain forms one given first-type time window; and the given first-type slot group includes not less than 2 slots.

In one subembodiment, the given first-type time window includes a positive integer number of consecutive slots.

In one subembodiment, the given first-type slot set includes a positive integer number of consecutive slots.

In one subembodiment, the number of slots included in the given first-type time window is a positive integer multiple of the number of slots included in the given first-type slot set.

In one subembodiment, the given first-type time window corresponds to a configured periodicity for CSS of a given type.

In one subembodiment, other UEs that use the same DRX periodicity as the UE search for paging related information in the given first-type slot subset.

In one subembodiment, other UEs that use the same eDRX periodicity as the UE search for paging related information in the given first-type slot subset.

### Embodiment 9

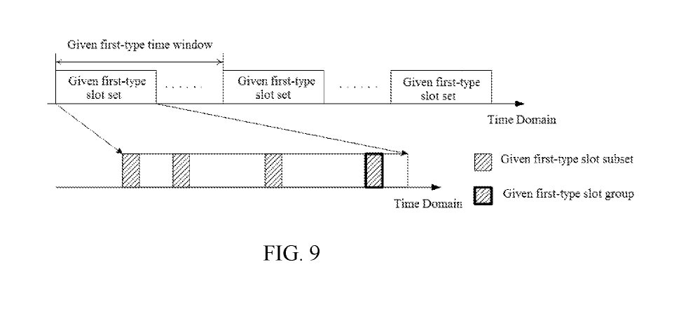

Embodiment 9 illustrates an example of a diagram of a given first-type time window, a given first-type slot set and a given first-type slot group, as shown in FIG. 9. In FIG. 9, the given first-type slot set is any one of the K first-type slot sets in the present disclosure, and the given first-type slot group is the first-type slot group among the K first-type slot groups that belongs to the given first-type slot set; a periodicity between two given first-type slot sets adjacent in time domain forms one given first-type time window; and the given first-type slot group includes only 1 slot.

In one subembodiment, the given first-type time window includes a positive integer number of consecutive slots.

In one subembodiment, the given first-type slot set includes a positive integer number of consecutive slots.

In one subembodiment, the number of slots included in the given first-type time window is a positive integer multiple of the number of slots included in the given first-type slot set.

In one subembodiment, the given first-type time window corresponds to a configured periodicity for CSS of a given type.

In one subembodiment, other UEs that use the same DRX periodicity as the UE search for paging related information in the given first-type slot subset.

In one subembodiment, other UEs that use the same eDRX periodicity as the UE search for paging related information in the given first-type slot subset.

### Embodiment 10

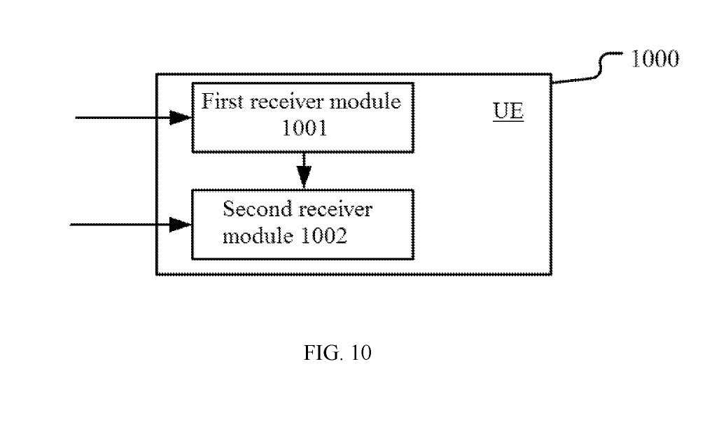

Embodiment 10 illustrates an example of a structure block diagram of a processing device in a UE, as shown in FIG. 10. In FIG. 10, the processing device 1000 in the UE is mainly composed of a first receiver module 1001 and a second receiver module 1002.

The first receiver module 1001 detects a first signaling in only K first-type slot groups in K first-type slot sets respectively.

The second receiver module 1002 receives a first radio signal.

In Embodiment 10, the K is a positive integer greater than 1; the K first-type slot groups belong to the K first-type slot sets respectively; any one first-type slot set of the K first-type slot sets includes a positive integer number of slots, and any one first-type slot group of the K first-type slot groups includes a positive integer number of slots; the positions of the K first-type slot groups in the K first-type slot sets are different from each other, and the positions of the K first-type slot groups in the K first-type slot sets are all related to an ID of the UE; the first signaling is used for determining paging related information; and the first signaling includes configuration information of the first radio signal.

In one subembodiment, the first receiver module 1001 further receives a second signaling; the second signaling is used for determining at least one of {K first-type time windows, the K first-type slot sets}, and the K first-type slot sets belongs to the K first-type time windows respectively; and any one first-type time window of the K first-type time windows consists of a positive integer number of consecutive slots.

In one subembodiment, the first receiver module 1001 further receives first information; and, the first information and a first ID are used together by the UE to determine the K first-type slot groups from the K first-type slot sets respectively.

In one subembodiment, a first parameter and the first ID are used together by the UE to determine the K first-type slot groups from the K first-type slot sets respectively, and the first parameter is randomly generated by the UE.

In one subembodiment, a second parameter and the first ID are used together by the UE to determine a given first-type slot group from a given first-type slot set, the given first-type slot set is one of the K first-type slot sets, the given first-type slot group is the first-type slot group among the K first-type slot groups that belongs to the given first-type slot set, the given first-type slot set belongs to a given first-type time window, and the second parameter is related to the given first-type time window.

In one subembodiment, the first receiver module 1001 includes at least the former three of {the receiver 456, the receiving processor 452, the paging processor 441, the controller/processor 490} mentioned in Embodiment 4.

In one subembodiment, the second receiver module 1002 includes at least the former two of {the receiver 456, the receiving processor 452, the controller/processor 490} mentioned in Embodiment 4.

### Embodiment 11

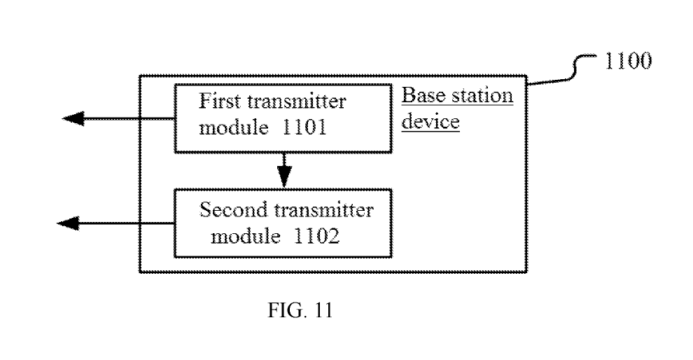

Embodiment 11 illustrates an example of a structure block diagram of a processing device in a base station device, as shown in FIG. 11. In FIG. 11, the processing device 1100 in the base station device is mainly composed of a first transmitter module 1101 and a second transmitter module 1102.

The first transmitter module 1101 transmits a first signaling in only K first-type slot groups in K first-type slot sets respectively.

The second transmitter module 1102 transmits a first radio signal.

In Embodiment 11, the K is a positive integer greater than 1; the K first-type slot groups belong to the K first-type slot sets respectively; any one first-type slot set of the K first-type slot sets includes a positive integer number of slots, and any one first-type slot group of the K first-type slot groups includes a positive integer number of slots; the positions of the K first-type slot groups in the K first-type slot sets are different from each other, the positions of the K first-type slot groups in the K first-type slot sets are all related to an ID of a first terminal, and a receiver of the first signaling includes the first terminal; the first signaling is used for determining paging related information; and the first signaling includes configuration information of the first radio signal.

In one subembodiment, the first transmitter module 1101 further transmits a second signaling; the second signaling is used for determining at least one of {K first-type time windows, the K first-type slot sets}, and the K first-type slot sets belongs to the K first-type time windows respectively; and any one first-type time window of the K first-type time windows consists of a positive integer number of consecutive slots.

In one subembodiment, the first transmitter module 1101 further transmits first information; and, the first information and a first ID are used together by the base station device to determine the K first-type slot groups from the K first-type slot sets respectively.

In one subembodiment, a first parameter and the first ID are used together by the first terminal to determine the K first-type slot groups from the K first-type slot sets respectively, and the first parameter is randomly generated by the first terminal.

In one subembodiment, a second parameter and the first ID are used together by the first terminal to determine a given first-type slot group from a given first-type slot set, the given first-type slot set is one of the K first-type slot sets, the given first-type slot group is the first-type slot group among the K first-type slot groups that belongs to the given first-type slot set, the given first-type slot set belongs to a given first-type time window, and the second parameter is related to the given first-type time window.

In one subembodiment, the first transmitter module 1101 includes at least the former three of {the transmitter 416, the transmitting processor 415, the paging processor 471, the controller/processor 440} mentioned in Embodiment 4.

In one subembodiment, the second transmitter module 1102 includes at least the former two of {the transmitter 416, the transmitting processor 415, the controller/processor 440} mentioned in Embodiment 4.

The ordinary skill in the art may understand that all or part steps in the above method may be implemented by instructing related hardware through a program. The program may be stored in a computer readable storage medium, for example Read-Only Memory (ROM), hard disk or compact disc, etc. Optionally, all or part steps in the above embodiments also may be implemented by one or more integrated circuits. Correspondingly, each module unit in the above embodiment may be realized in the form of hardware, or in the form of software function modules. The present disclosure is not limited to any combination of hardware and software in specific forms. The UE and terminal in the present disclosure include but not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things, REID terminals, NB-IOT terminals, Machine Type Communication (MTC) terminals, enhanced MTC (eMTC) terminals, data cards, low-cost mobile phones, low-cost tablet computers, etc. The base station in the present application includes but not limited to macro-cellular base stations, micro-cellular base stations, home base stations, relay base station, NR node B, TRP, and other radio communication equipment.

The above are merely the preferred embodiments of the present disclosure and are not intended to limit the scope of protection of the present disclosure. Any modification, equivalent substitute and improvement made within the spirit and principle of the present disclosure are intended to be included within the scope of protection of the present disclosure.

What is claimed is:

1. A method in a User Equipment (UE) for wireless communication, comprising:
for K first-type slot sets, detecting a first signaling in only K first-type slot groups therein respectively; and
receiving a first radio signal;
wherein the K is a positive integer greater than 1; the K first-type slot groups belong to the K first-type slot sets respectively; any one first-type slot set of the K first-type slot sets comprises a positive integer number of slots, and any one first-type slot group of the K first-type slot groups comprises a positive integer number of slots; the positions of the K first-type slot groups in the K first-type slot sets are different from each other, and the positions of the K first-type slot groups in the K first-type slot sets are all related to an ID of the UE; the first signaling is used for determining paging related information; and the first signaling comprises configuration information of the first radio signal.

2. The method according to claim 1, comprising:
receiving a second signaling;
wherein the second signaling is used for determining at least one of {K first-type time windows, the K first-type slot sets}, and the K first-type slot sets belongs to the K first-type time windows respectively; and any one first-type time window of the K first-type time windows consists of a positive integer number of consecutive slots.

3. The method according to claim 1, comprising:
receiving first information;
wherein the first information and a first ID are used together by the UE to determine the K first-type slot groups from the K first-type slot sets respectively.

4. The method according to claim 1, wherein a first parameter and the first ID are used together by the UE to determine the K first-type slot groups from the K first-type slot sets respectively, and the first parameter is randomly generated by the UE; or, a second parameter and the first ID are used together by the UE to determine a given first-type slot group from a given first-type slot set, the given first-type slot set is one of the K first-type slot sets, the given first-type slot group is the first-type slot group among the K first-type slot groups that belongs to the given first-type slot set, the given first-type slot set belongs to a given first-type time window, and the second parameter is related to the given first-type time window.

5. The method according to claim 1, wherein the K first-type slot sets correspond to K kinds of different configured periodicities and configured modes for Common Search Space (CSS) respectively; and the K first-type slot sets are reserved for CSS, or each of the K first-type slot sets comprises CSS for the UE, or the K first-type slot sets are used to transmit at least one of {SSB, PBCH, RMSI}.

6. A method in a base station for wireless communication, comprising:
for K first-type slot sets, transmitting a first signaling in only K first-type slot groups therein respectively; and
transmitting a first radio signal;
wherein the K is a positive integer greater than 1; the K first-type slot groups belong to the K first-type slot sets respectively; any one first-type slot set of the K first-type slot sets comprises a positive integer number of slots, and any one first-type slot group of the K first-type slot groups comprises a positive integer number of slots; the positions of the K first-type slot groups in the K first-type slot sets are different from each other, the positions of the K first-type slot groups in the K first-type slot sets are all related to an ID of a first terminal, and a receiver of the first signaling comprises the first terminal; the first signaling is used for determining paging related information; and the first signaling comprises configuration information of the first radio signal.

7. The method according to claim 6, comprising:
transmitting a second signaling;
wherein the second signaling is used for determining at least one of {K first-type time windows, the K first-type slot sets}, and the K first-type slot sets belongs to the K first-type time windows respectively; and any one first-type time window of the K first-type time windows consists of a positive integer number of consecutive slots.

8. The method according to claim 6, comprising:
transmitting first information;
wherein the first information and a first ID are used together by the first terminal to determine the K first-type slot groups from the K first-type slot sets respectively.

9. The method according to claim 6, wherein a first parameter and the first ID are used together by the first terminal to determine the K first-type slot groups from the K first-type slot sets respectively, and the first parameter is randomly generated by the first terminal; or, a second parameter and the first ID are used together by the first terminal to determine a given first-type slot group from a given first-type slot set, the given first-type slot set is one of the K first-type slot sets, the given first-type slot group is the first-type slot group among the K first-type slot groups that belongs to the given first-type slot set, the given first-type slot set belongs to a given first-type time window, and the second parameter is related to the given first-type time window.

10. The method according to claim 6, wherein the K first-type slot sets correspond to K kinds of different configured periodicities and configured modes for CSS respectively; and the K first-type slot sets are reserved for CSS, or each of the K first-type slot sets comprises CSS for the UE, or the K first-type slot sets are used to transmit at least one of {SSB, PBCH, RMSI}.

11. A UE for wireless communication, comprising:
a first receiver module, to detect a first signaling in only K first-type slot groups in K first-type slot sets respectively; and
a second receiver module, to receive a first radio signal;
wherein the K is a positive integer greater than 1; the K first-type slot groups belong to the K first-type slot sets respectively; any one first-type slot set of the K first-type slot sets comprises a positive integer number of slots, and any one first-type slot group of the K first-type slot groups comprises a positive integer number of slots; the positions of the K first-type slot groups in the K first-type slot sets are different from each other, and the positions of the K first-type slot groups in the K first-type slot sets are all related to an ID of the UE; the first signaling is used for determining paging related information; and the first signaling comprises configuration information of the first radio signal.

12. The UE according to claim 11, wherein the first receiver module further receives a second signaling; the second signaling is used for determining at least one of {K first-type time windows, the K first-type slot sets}, and the K first-type slot sets belongs to the K first-type time windows respectively; and any one first-type time window of the K first-type time windows consists of a positive integer number of consecutive slots.

13. The UE according to claim 11, wherein the first receiver module further receives first information; and, the first information and a first ID are used together by the UE to determine the K first-type slot groups from the K first-type slot sets respectively.

14. The UE according to claim 11, wherein a first parameter and the first ID are used together by the UE to determine the K first-type slot groups from the K first-type slot sets respectively, and the first parameter is randomly generated by the UE; or, a second parameter and the first ID are used together by the UE to determine a given first-type slot group from a given first-type slot set, the given first-type slot set is one of the K first-type slot sets, the given first-type slot group is the first-type slot group among the K first-type slot groups that belongs to the given first-type slot set, the given first-type slot set belongs to a given first-type time window, and the second parameter is related to the given first-type time window.

15. The UE according to claim 11, wherein the K first-type slot sets correspond to K kinds of different configured periodicities and configured modes for CSS respectively; and the K first-type slot sets are reserved for CSS, or each of the K first-type slot sets comprises CSS for the UE, or the K first-type slot sets are used to transmit at least one of {SSB, PBCH, RMSI}.

16. A base station device for wireless communication, comprising:
a first transmitter module, to transmit a first signaling in only K first-type slot groups in K first-type slot sets respectively; and
a second transmitter module, to transmit a first radio signal;
wherein the K is a positive integer greater than 1; the K first-type slot groups belong to the K first-type slot sets respectively; any one first-type slot set of the K first-type slot sets comprises a positive integer number of slots, and any one first-type slot group of the K first-type slot groups comprises a positive integer number of slots; the positions of the K first-type slot groups in the K first-type slot sets are different from each other, the positions of the K first-type slot groups in the K first-type slot sets are all related to an ID of a first terminal, and a receiver of the first signaling comprises the first terminal; the first signaling is used for determining paging related information; and the first signaling comprises configuration information of the first radio signal.

17. The base station device according to claim 16, wherein the first transmitter module further transmits a second signaling; the second signaling is used for determining at least one of {K first-type time windows, the K first-type slot sets}, and the K first-type slot sets belongs to the K first-type time windows respectively; and any one first-type time window of the K first-type time windows consists of a positive integer number of consecutive slots.

18. The base station device according to claim 16, wherein the first transmitter module further transmits first information; and, the first information and a first ID are used together by the base station device to determine the K first-type slot groups from the K first-type slot sets respectively.

19. The base station device according to claim 16, wherein a first parameter and the first ID are used together by the first terminal to determine the K first-type slot groups from the K first-type slot sets respectively, and the first parameter is randomly generated by the first terminal; or, a second parameter and the first ID are used together by the first terminal to determine a given first-type slot group from a given first-type slot set, the given first-type slot set is one of the K first-type slot sets, the given first-type slot group is the first-type slot group among the K first-type slot groups that belongs to the given first-type slot set, the given first-type slot set belongs to a given first-type time window, and the second parameter is related to the given first-type time window.

20. The base station device according to claim 16, wherein the K first-type slot sets correspond to K kinds of different configured periodicities and configured modes for CSS respectively; and the K first-type slot sets are reserved for CSS, or each of the K first-type slot sets comprises CSS for the UE, or the K first-type slot sets are used to transmit at least one of {SSB, PBCH, RMSI}.
